(19) United States
(12) Patent Application Publication
(10) Pub. No.: US 2024/0149285 A1
(43) Pub. Date: May 9, 2024

(54) DISPENSER, CARTRIDGE ASSEMBLY, SUPPORT SLEEVE AND METHOD OF OPERATING A DISPENSER

(71) Applicant: medmix Switzerland AG, Haag (CH)

(72) Inventors: Hayden TURNER, Ayer, MA (US); Ralf GRÜNENFELDER, Wangs (CH); Mark TINKLER, Hampshire (GB)

(21) Appl. No.: 18/279,869

(22) PCT Filed: Feb. 25, 2022
(86) PCT No.: PCT/EP2022/054834

§ 371 Date: Aug. 31, 2023

(30) Foreign Application Priority Data
Mar. 1, 2021 (EP) 21160008.5

(51) Int. Cl. B05B 12/00; B05B 9/08; B05B 15/70; B05C 17/005

(52) U.S. Cl. CPC B05B 12/002; B05B 9/0838; B05B 9/0861; B05B 15/70; B05C 17/00589

(57) ABSTRACT

A dispenser for spray applications includes a receptacle for repeatedly receiving a cartridge, a plunger moveable for dispensing, and a spray nozzle for activating a spray application and a trigger.

### CROSS-REFERENCE TO RELATED APPLICATION

This application is a U.S. National Stage application of International Application No. PCT/EP2022/054834, filed Feb. 25, 2022, which claims priority to European Application No. 21160008.5, filed Mar. 1, 2021, the contents of each of which are hereby incorporated by reference.

### BACKGROUND

### Technical Field

The disclosure relates to a dispenser for spray applications, the dispenser comprising a receptacle for repeatedly receiving a cartridge, in particular a collapsible cartridge, a plunger moveable for dispensing, a spray nozzle for activating a spray application and a trigger. The disclosure further relates to a cartridge assembly, to a support sleeve for a cartridge assembly and to a method of operating a dispenser.

### Background Information

Dispensers are used to dispense various types of materials in various fields of application. Cartridges are frequently used to store liquid flowable, frequently pasty or viscous to highly viscous substances, such as paints, sealants and adhesives in the industrial sector, for example the automotive, nautical and aeronautical industries, in the construction industry, for example of buildings and structures, such as bridges, and also in the dental sector and medical sector.

Various types of dispensers are available to dispense materials for the respective application as required. Examples for such substances are joint sealing compounds, compounds for chemical dowels or chemical anchors, adhesives, pastes or impression materials in the dental sector. These cartridges are usually produced from plastic and are manufactured in an injection molding process.

### SUMMARY

A distinction is made between single-component systems in which the material to be dispensed is only made of one component and two-component or multicomponent systems in which at least two different components are stored in separate chambers of the same cartridge or in separate cartridges, wherein the components are intimately mixed on dispensing by a dynamic or static mixing apparatus. Examples for this are two-component adhesives or chemical dowels which only harden after the mixing of the two components. Two-component systems are in particular also used in the industrial sector for paints which are often used to generate functional protective layers such as for corrosion protection.

For reasons of environmental protection, film bag cartridges are increasingly being used. In contrast to regular cartridges which are completely produced from plastic in an injection molding process, at least parts of film cartridges are designed as a film. Usually the cartridge wall(s) bounding the cartridge chamber(s) is/are made of a film which is connected to a head part made of rigid material, e.g., plastic, comprising the dispensing outlet. This has several advantages. On the one hand, the unfilled film cartridges can be stored and transported in a collapsed state from the cartridge manufacturers to the manufacturers of the filling materials (media) who then take care of the filling of the empty cartridges. Only after being filled, the film cartridge is in its expanded state which is comparable in size to a regular non-collapsible cartridge. This means that the necessary space for storage and for transportation can be reduced, since the collapsed cartridges have a reduced size in comparison to regular non-collapsible cartridges.

On the other hand, once the cartridges have been used, i.e., reduced to the collapsed state by dispensing the filling material, the cartridges are significantly reduced in size and weight in comparison to regular cartridges so that the cost of disposal is also reduced. In any case the carbon footprint associated with the film cartridges is reduced in comparison to plastic cartridges that are completely formed in an injection molding process.

The materials are stored in cartridges, and these can be repeatedly replaced at the dispensers once the materials stored therein are either no longer required for a certain application or have been used up.

It is an object of the present application to provide a dispenser that is simple to use particularly with film bag cartridges, which reduces the waste on removal of the film bag cartridge and that can be produced in a simple manner. It is a further object of the disclosure to make available a corresponding cartridge assembly that can be placed into the dispenser in an as simple as possible manner that is similarly cost effective in its manufacture.

This object is satisfied in accordance with the subject matter disclosed herein. Such a dispenser is preferably suitable for spray applications, the dispenser can comprise a receptacle for repeatedly receiving a cartridge, in particular a cartridge assembly comprising a collapsible cartridge, a piston connectable to a rack moveable through the receptacle for urging materials stored inside the cartridge, in particular stored in a film bag of the cartridge, towards an outlet of the cartridge for dispensing the materials stored therein, the piston preferably being permanently connected to the rack, a spray nozzle lever for activating a spray application and a trigger for activating both a movement of the rack of the dispenser in the direction of the receptacle and of the spray nozzle lever between first and second positions.

Such a dispenser is particularly suited to spray applications, as activation of the trigger can activate both a movement of the rack of the dispenser for dispensing the materials stored in a cartridge arranged in a receptacle thereof. Moreover, an activation of the trigger can also activate the spray nozzle lever to urge a spray nozzle of the cartridge stored in the receptacle.

The fact that the piston is arranged at the rack, preferably via a permanent connection such as a screw connection or a bonded connection, also means cartridges without internal pistons can be used, thereby reducing the waste on disposal of the cartridge or cartridge assembly.

Particularly having regard to paint applications spray cans are typically pressurized in order to enable the paint to be dispensed via the spray nozzle, such spray cans should not be disposed of in the normal garbage as the pressurized containers are particularly bad for the environment. By storing, for example, the paint in a film bag which is pressurized during the dispensing process via the piston and the rack of the dispenser rather than being inherently pressurized means that less environmentally damaging containers can be used for spray applications.

In this connection it is noted that the piston can either be directly connected to the rack or indirectly. In the latter case, further components of the dispenser can be arranged between the piston and the rack. Another alternative can be that the piston is only functionally connected to the rack, i.e., the piston will be moved through the receptacle by the rack in order to urge materials stored inside the cartridge towards the outlet. However, in such cases it is not necessary for the piston to be physically connected to the rack or any other component of the dispenser. That is, the piston can be a separate component.

Additionally or alternatively such a dispenser comprises a receptacle for repeatedly receiving a cartridge assembly comprising a collapsible cartridge, preferably having a trumpet shaped end, a piston connectable to a rack moveable through the receptacle and configured to urge a film bag of the collapsible cartridge towards an outlet of the collapsible cartridge for dispensing materials stored therein, the piston being permanently connected to the rack, and a trigger for activating a movement of the rack of the dispenser in the direction of the receptacle.

The trumpet shape of the second end of the sleeve can be formed in various ways, such as for example via plastic molding, swaging of plastic or metal extrusions and/or by forming a separate part which can be added, i.e., fixed, to an extrusion of plastic or metal. Hence, one can clearly see that there are multiple possibilities to form the trumpet shape of the second end of the sleeve.

By always maintaining the piston at the dispenser, the piston is not accidentally disposed of on disposal of the cartridge leading to reduced waste, but also spray applications can be carried out without the need of inherently pressurized containers.

The dispenser can, for example, be used for the dispensing of construction material, sealants, bonding material, adhesives, paints, coatings, protective coatings, other viscus materials such as caulk and/or adhesives for all kinds of dispensers, i.e., manual, cordless and pneumatic.

The piston is preferably designed for use with film bag cartridges. The piston can comprise a piston base, an intermediate portion and a piston head, wherein a longitudinal axis extends from the piston base through the intermediate portion and through the piston head, the piston further comprising a plurality of lip sections extending radially outwardly with respect to the longitudinal axis from a sidewall of the piston head the piston base and the piston head being axially spaced apart from one another along the extension axis by the intermediate portion, with a gap being present between the piston base and the plurality of lip sections, wherein the plurality of lip sections are respectively spaced apart from one another by slits formed between two neighboring lip sections, with the plurality of slits extending in a radial direction with respect to the extension axis of the piston, wherein the piston base, the intermediate portion, the piston head and the plurality of lip sections are formed as one piece.

The piston can be of one-piece design, i.e., the piston base, the piston head and the intermediate portion are integrally formed in one and the same injection mold in one injection molding step. On reducing the number of injection molding tools, the pistons can be produced in one piece in a more facile and a more reproducible manner which thus leads to a more cost effective manufacture of the pistons, as one does not require the use of multiple processing tools.

As the piston is moved by the rack into an inserted cartridge assembly to discharge the material stored in the film bag, the film bag is deflated leaving an emptied film bag. In order to collect the empty part of the film bag, the reusable cartridge piston can comprise an annular groove, which is defined between the plurality of lip sections and the sidewall of the piston head. In other words, the annular groove defined between the plurality of lip sections and the sidewall of the piston head receives or wraps up the emptied film bag.

During the collection of the film bag, it is important that the film bag does not arrive between the piston and the inner wall of the support sleeve in order to avoid the film bag from being ruptured. To avoid such incidents, each of the plurality of lip sections can contact the inner wall of the support sleeve, when the reusable cartridge piston is inserted into the support sleeve. For this purpose, an outer diameter defined by the plurality of lip sections is larger than an inner diameter of the support sleeve of the associated cartridge assembly. Furthermore, each of the plurality of the lip sections can be resilient, that is each of the respective lip sections is moveable relative to the piston head and the piston base. Therefore, when the piston is inserted into a support sleeve of the cartridge assembly, each of the plurality of the lip sections pushes against the inner wall of the support sleeve with its respective spring force.

In this connection it should be noted that the outer diameter of the piston as defined by the plurality of lip sections can also be equal to or smaller than the inner diameter of the support sleeve. In this way the friction between the support sleeve and the piston can be reduced and account can be taken of production tolerances of the piston and the support sleeve.

However, to ensure that the resilient lip sections are not bent over or even break away from the piston head as the piston is moved along the discharging axis of the reusable cartridge, the gap between the piston head and the piston base is preferably 0.8 to 1.2 mm wide in the direction of the extension axis of the reusable cartridge piston. The piston base can act as a support for the bent lip sections which can then avoid the lip sections from being bent too much, in particular if a diameter of the piston head is smaller than a diameter of the piston base.

Furthermore, if the diameter of the piston head is smaller than the diameter of the piston base, sufficient support for the collected empty film bag is provided.

Preferably, the outer diameter of the piston base corresponds to the inner diameter of the support sleeve into which the film bag and the piston are inserted, so that the piston base is at least partially in contact with the inner wall of the sleeve. Such a configuration of the piston base allows for a secure guidance of the piston in the support sleeve during the movement of the piston along a discharge axis of the reusable cartridge, respectively of the dispenser. Furthermore, if the diameter defined by the plurality of the lip sections is larger than the diameter of the piston base, it is ensured that the plurality of lip sections push against the inner wall of the sleeve, when the piston is inserted into the sleeve, thereby preventing that the emptied bag gets between the piston and the inner wall of the sleeve.

Optimum results with regard to emptying the film bag as completely as possible and ideally entirely are achievable if the piston head preferably comprises a front face which faces away from the piston base of the piston and which forms a flat plane or an at least substantially flat plane. This reduces the amount of waste left behind in a film bag cartridge.

Discharging properties can be further enhanced if the front face of the piston head is spaced further apart from the piston base than the lip sections. In other words, the front face of the piston head projects beyond the outermost tips of each of the lip sections. By numbers, the front face preferably projects by 5% to 50% of the height of the piston beyond each of the lip sections. Furthermore, if the piston head is spaced further apart from the piston base than the lip sections, sufficient space for collecting the emptied film bag is provided.

Optimum results with regard to the flexibility of each of the lip sections are achieved, when the plurality of slits separating the plurality of lip sections preferably extend from the outside radially inwardly to the sidewall of the piston head. Preferably, at least one of the plurality of slits can pass over into a channel present in the sidewall of the piston head. It is even more preferred, if each of the plurality of slits passes over into a channel present in the sidewall of the piston head. The channels can be basically aligned in parallel to the extension axis of the piston. Such an alignment of the channels promotes sufficient emptying of the film bag.

In this connection it should be noted that a gap formed between directly adjacent lip sections is non-uniform, especially wherein the gap comprises first and second slit sections, with a spacing between the first slit sections being smaller than a spacing between the second slit sections. By forming the gap non-uniform the tools used for an injection mold can be simplified making it possible simpler to form a one-piece piston and hence facilitates the reduction of the cost of manufacture of the piston.

Preferably the processing tool for fabricating the reusable cartridge piston is an injection molding tool. In order to avoid undesired shrinkage of the injection molded piston during its cooling, and in particular to avoid undesired shrinkage of the plurality of lip sections of the piston, at least one of the inner surfaces of the plurality of lip sections facing the sidewall of the piston head can comprise at least one recess.

Preferred materials used for the fabrication of the reusable cartridge piston can be in particular POM, PTFE, PA or a polymer or a thermoset material having a hardness measured with the Shore D Durometer selected in the range of 55 D to 100 D. Most preferably, the reusable cartridge piston is made of only one composition, preferably comprises only one polymeric material.

The polymeric material can include polymer blends, i.e., can also contain additives, primers and/or polar groups and cannot be one single virgin polymer.

In this connection it should further be noted that a material of the piston can be one of polyethylene (PE), high density polyethylene (HD-PE), polybutylene terephthalate (PBT), polyamide (PA) and polypropylene (PP).

Since the piston can need to be replaced, e.g., due to failure of the piston or a part thereof, or maintained e.g. due to contamination present at the piston, it is beneficial if the piston is screwed to the rack using a bolt or a nut integrally formed within the piston that can be coupled to a nut or a bolt present at the rack.

A sealing element can be arranged at the piston, preferably at the piston base, in order to enhance a seal between the piston and the support sleeve with which it cooperates. The sealing element can comprise an O-ring, such as an ethylene propylene diene monomer rubber (EPDM) O-ring or a silicone O-ring.

It should further be noted that the pistons described herein can be used in a plurality of different types of cartridges, for example, one or multi-component cartridges. If e.g. a two-component cartridge is used this can be formed as a side-by-side cartridge, a coaxial cartridge or a cartridge formed by joining two single component cartridges e.g. by a “click together” process such as a snap-fit connection or the like.

The dispenser can further comprise a spray nozzle lever for activating a spray application and the trigger is configured to activate both a movement of the rack of the dispenser in the direction of the receptacle and of the spray nozzle lever between first and second positions.

According to another embodiment the cartridge of the dispenser can be one of a collapsible cartridge and a film bag cartridge. That is, it is generally possible to use the dispenser with both kinds of cartridges, solid cartridges and film bag cartridges.

The dispenser can further comprise a motor, for example an electric motor, optionally driven by a battery, wherein the rack is driven by the motor. Such a motor can advantageously be used to automatically dispense materials stored in the cartridge in an as simple manner as possible without the need of a user applying his or her own energy for the dispensing process.

The dispenser can further comprise a controller, the controller being adapted to vary at least one of a speed of the motor, and a power output of the motor, the controller optionally being configured to detect a pressure on the piston or a parameter related thereto and to adapt the speed of the motor, and the power output of the motor in dependence on the detected pressure or the parameter related thereto.

Such a controller can advantageously be used to control the operation of the dispenser and hence facilitate the use thereof.

The controller can be configured to drive the rack and on reaching a threshold value for a pressure on the piston or a parameter related thereto is configured to stop driving the rack for a pre-defined time period and to drive the rack again following the pre-defined time period. In this way one can ensure that the pressure on the materials stored in the cartridge is reliably monitored during the use of the dispenser.

In use of the dispenser the dispenser can drive the rack until it reaches a pre-defined pressure on the film bag exerted by the piston whereupon it stops dispensing. The pre-defined pressure can, for example, lie in the range of 110 to 150% of the usual dispense pressure that is exerted by the piston on the film bag during dispense. In some embodiments the pre-defined pressure can also lie in the range of 120 to 140% of the usual dispense pressure. Upon reaching the pre-defined pressure, the motor can then slightly retract the rack while being stopped. After a pre-defined time period, the dispenser can then start the motor again to drive the rack forward at 100% of the dispense pressure.

The rack can be retracted following a stop of the motor in order to reduce the pressure on the clutch so that the clutch can be released. This can be done at a motor speed reduced with respect to 100% of the motor speed, by way of example at a motor speed selected in the range of 20% to 40%, e.g., 30% or around 30%, where 100% of the motor speed is the speed at which the motor operates during normal dispense.

The pressure on the piston or the parameter related thereto can be determined by one of a motor current, i.e., a momentary power output of the motor, a pressure sensor and a strain gauge. In this way one can efficiently and reliably detect parameters related to the use of the dispenser.

The spray nozzle lever can be moved by a cable, in particular a Bowden cable. The use of a Bowden cable makes available a cost effective, technically simple and reliable activation mechanism for the spray nozzle lever.

The trigger can be connected to a switch via a spring, in particular wherein the spring is of L-shape. The spring can bias the trigger such that once a user stops activating the trigger this is reliably biased into the position of non-use, i.e., a storage state of the dispensers.

In this connection it should be noted that the spray nozzle lever can be moved before, after or during the activation of the switch, preferably the spray nozzle lever is always moved into the spray position during the activation of the switch, i.e., when the trigger is activated.

The dispenser can further comprise a wheel arranged at a front end of the dispenser at the spray nozzle lever. Such a wheel can be used for spray applications where the dispenser is used to e.g. paint lines or the like on the ground or at walls.

A latching mechanism can be arranged at the end of the dispenser having the spray nozzle lever and the wheel, the latching mechanism being configured to latch the wheel into a first spray position and a second spray position. Such a latching mechanism can be used to move the wheel into and out of a position of use. By way of example, the latching mechanism can be formed by clips that hold the wheel in the different positions.

The dispenser can further comprise a clutch configured to engage and disengage the rack to allow manual pushing and pulling of the rack. Such a simple to use clutch allows the rack to be retracted. e.g., using a hook shaped handle thereof, for removal and possible replacement of the cartridge.

According to some embodiments it can be possible that the motor reverses its direction for a short period of time when the trigger of the dispenser is released or when the piston reaches its end of travel. This way the load on the clutch can be reduced such that the disengagement of the clutch can be facilitated even further. The short period of time can, for example, lie in the range of 0.01 to 3 s, preferably in the range of 0.1 to 2 s.

According to a further aspect the present disclosure also relates to a cartridge assembly for insertion into a dispenser, the cartridge assembly comprising a collapsible cartridge having a film cartridge wall and a solid head part, a support sleeve comprising first and second ends and a longitudinal axis extending between the first and second ends, the support sleeve being configured to receive the collapsible cartridge and the first end being configured to be connected to the head part, and the second end of the sleeve extending radially outwardly from the longitudinal axis, i.e. having a trumpet shape.

The trumpet shaped second end facilitates the insertion of the piston of the dispenser into the second sleeve, this is because the piston is generally dimensioned such that none of the material of the film bag is caught between the support sleeve and the piston which could damage the film bag and hence cause the material stored therein to come into direct contact with moveable parts of the dispenser and hence possibly influence the working thereof.

The trumpet shape of the second end of the sleeve can be formed in various ways, such as for example via plastic molding, swaging of plastic or metal extrusions and/or by forming a separate part which can be added, i.e., fixed, to an extrusion of plastic or metal. Hence, one can clearly see that there are multiple possibilities to form the trumpet shape of the second end of the sleeve.

The shape of the second end of the cartridge acts as an insertion aid to guide the piston of the dispenser into the cartridge.

Moreover, through a suitable selection of the parts of the cartridge assembly, e.g., of the film bag, the head part and the support sleeve, e.g., from plastic materials, e.g., thermoplastic elastomers and/or thermoplastic polymers, this can be produced in an as environmentally friendly manner using known techniques in an as cost-effective way as possible.

The first end of the support sleeve can comprise two to 15 noses adapted to be connected to the solid head part of the collapsible cartridge. Such noses can engage into grooves or depressions of the head part in order to hold the support sleeve at the head part.

The head part can comprise an annular groove in which the noses are received, preferably by a snap-in connection or the like. In this way an as simple as possible connection between the support sleeve and the head part is made available that can be reliably used in an as simple as possible way.

The second end can further comprise a plurality of reinforcing ribs on an outer surface of the second end. The trumpet shaped sleeve can experience issues on removal from an injection mold causing the support sleeve to crack, the reinforcing ribs prevent the cracking of the support sleeve on removal from such an injection mold.

In this connection it should be noted that the reinforcing ribs can also extend over at least 10%, preferably at least 20% of an overall length of the support sleeve.

The cartridge assembly can further comprise a spray nozzle connected to an outlet of the head part of the collapsible cartridge. Such a spray nozzle facilitates the dispensing of e.g., paints or adhesives from the cartridge assembly.

A seal can be arranged between an outer first end surface of the spray nozzle and an inner surface of an outlet passage of the outlet of the head part of the collapsible cartridge. The seal can prevent materials exiting the cartridge of the cartridge assembly from entering regions of the spray nozzle which are to be kept remote from these materials in order to ensure continuous operation of the spray nozzle, particularly if the same cartridge assembly is used over a period of several days, months for small individual applications.

The spray nozzle can be crimped into place at the outlet of the head part of the collapsible cartridge by a metal plate being folded into an undercut present at an outer surface of the outlet. By crimping the metal plate of the spray nozzle to an outer side of the outlet rather than to an inner surface of the outlet the crimping process can be significantly simplified, as can the structures required for the crimping process, so that less complex parts have to be manufactured leading to a further reduction of the costs of manufacture of such a cartridge assembly.

The head part can have a double layered structure with first and second layers being connected to one another via a plurality of walls extending in parallel to the longitudinal axis of the support sleeve when the head part is attached to the support sleeve.

Such a head part comprises a sandwich structure for reinforcing the head part such that this can withhold the pressures exerted thereon while the materials stored in the cartridge are being dispensed using a suitable dispenser.

According to another aspect the present disclosure relates to a further cartridge assembly for insertion into a dispenser according to the disclosure. The cartridge assembly comprises a solid cartridge having a solid cartridge wall and a solid head part. It further comprises a support sleeve comprising first and second ends and a longitudinal axis extending between the first and second ends, the support sleeve being configured to receive the solid cartridge. The first end is configured to be connected to the head part, and the second end of the sleeve extends radially outwardly from the longitudinal axis, i.e., it has a trumpet shape.

According to another embodiment the cartridge comprises first, and second wall ends, wherein the first wall end comprises the head part and the second wall end extends radially outwardly from a longitudinal axis extending between the first and second wall ends, in particular the longitudinal axis (A) of the support sleeve. That is, also the second wall end of the cartridge has a trumpet shape. Hence, according to this embodiment both the cartridge as well as the support sleeve comprise a trumpet shaped second end such that the cartridge can be easily inserted in the support sleeve.

According to yet a further aspect the present disclosure relates to a support sleeve for a cartridge assembly, the support sleeve comprising first and second ends and a longitudinal axis extending between the first and second ends, the support sleeve being configured to receive the collapsible cartridge and the first end being configured to be connected to the head part, the second end of the support sleeve extending radially outwardly from the longitudinal axis.

Such a support sleeve can be reliably used with a cartridge assembly and/or a dispenser as described herein. The trumpet shaped end of the support sleeve ensures that this can be reliably placed at a dispenser comprising an inherent piston for a collapsible cartridge.

The trumpet shape of the second end of the sleeve can be formed in various ways, such as for example via plastic molding, swaging of plastic or metal extrusions and/or by forming a separate part which can be added, i.e., fixed, to an extrusion of plastic or metal Hence, one can clearly see that there are multiple possibilities to form the trumpet shape of the second end of the sleeve.

The first end of the support sleeve can comprise two to 15 noses, preferably adapted to be connected to the head part of the collapsible cartridge. In this way the support sleeve can be reliably connected to a cartridge in an as fast and reliable manner as possible.

At least the second end can further comprise a plurality of reinforcing ribs on an outer surface of the second end. Such reinforcing ribs, on the one hand ensure a reliable manufacture of the support sleeve, and on the other hand, strengthen that part of the support sleeve that has the largest forces acting thereon on installation of the support sleeve at a dispenser having an inherently installed piston.

A material can be stored in the collapsible cartridge of the cartridge assembly, such a material can comprise one of the following materials: topical medications, medical fluids, wound care fluids, cosmetic and/or skin care preparations, dental fluids, veterinary fluids, adhesive fluids, disinfectant fluids, protective fluids, paints and combinations of the foregoing.

Such fluids and hence the cartridge can therefore be expediently used in the treatment of target areas such as the nose (e.g. anti-histaminic creams etc.), ears, teeth (e.g. molds for implants or buccal applications (e.g. aphtas, gum treatment, mouth sores etc.), eyes (e.g. the precise deposition of drugs on eyelids (e.g. chalazion, infection, anti-inflammatory, antibiotics etc.), lips (e.g. herpes), mouth, skin (e.g. anti-fungal, dark spot, acne, warts, psoriasis, skin cancer treatment, tattoo removal drugs, wound healing, scar treatment, stain removal, anti-itch applications etc.), other dermatological applications (e.g. skin nails (for example anti-fungal applications, or strengthening formulas etc.) or cytological applications.

Alternatively, the fluids and hence the cartridge can also be used in an industrial sector both for the production of products as well as for the repair and maintenance of existing products, e.g., in the building industry, the automotive industry, the nautical industry, the aerospace industry, in the energy sector, e.g., for wind turbines, etc.

The support sleeve can further be configured to receive at least one of a collapsible cartridge, a solid cartridge and another cartridge of any kind.

According to a further aspect the present disclosure relates to a collapsible cartridge for use in a cartridge assembly and/or with a support sleeve, the collapsible cartridge comprising a film cartridge wall non-releasably attached to a collar of a solid head part, the head part comprising an outlet integrally formed therein and comprising a double layered structure with first and second layers as an end plate formed radially around the outlet, with the collar being formed at the second layer of the double layered structure extending in parallel to the longitudinal axis away from the first layer and with the first and second layers being connected to one another via a plurality of walls extending in parallel to the outlet and being connected to the outlet.

In this connection it should be noted that the cartridge can be a one-component cartridge comprising one cartridge wall. Alternatively, the cartridge can be a two-component cartridge comprising two cartridge walls, with a respective wall forming a film bag, i.e., a chamber provided e.g., for a hardener and the other one for a corresponding binder material. In this way the design presented herein can be used for a plethora of types of cartridges and applications.

Optionally each cartridge chamber of a two-component cartridge can be bounded by an own head part comprising a chamber outlet for the respective cartridge chamber, in particular with the head parts either being integrally formed or separately formed, with the separately formed head parts preferably being connectable to one another and/or connected to one another, e.g. via the chamber outlets; and/or with the chamber outlets together forming the dispensing outlet. This further illustrates the applicability of the current design for use with film cartridges.

The dispensing outlet can project from the rigid head part in a direction opposed to the direction of extent of the flexible film forming the at least one cartridge wall. In this way, e.g., a mixing tip, can be attached to the dispensing outlet in a facile manner.

The film can be a multi-layer film comprising at least two, three, four, five or more layers. Such films enable a longer storage life of the components stored in the cartridge in comparison to films made of only one material.

In this connection it should be noted that if the film bag comprises a fin seal rather than an overlap seal, the number of components of a multi-component film can be reduced, since the outer layer does not have to have a material common to the inner layer. The same is true for an extruded film bag.

Bulges can be present in an internal end face of the head part comprising the dispensing outlet. These bulges form channels through which a material of the head part can flow during the injection molding process and aid in the attachment of the film forming the cartridge wall.

In this connection the head part can have a Shore D hardness selected in the range of 40 to 99. Preferably the Shore D hardness of the head part lies in the range of 40 to 60.

The head part can comprise polyethylene, polypropylene, polyamide, polyethyleneterephthalate or polybutyleneterephthalate. The head part can for example comprise polyamide in the form of PA-6 (perlon) or PA-66 (nylon). Polyamide has the advantage that it has a good mechanical stability and is thus suitable for the head part.

Polyethyleneterephthalates (PET) can also be used for the head part. PET can namely be processed in a facile manner and has a good chemical resistance.

In accordance with an embodiment the head part is made of a high density PE (HDPE). High density polyethylene (HDPE) has a density in the range of 930 kg/m³ to 970 kg/m³ auf.

One can also consider forming the head part and/or the film bag of a material that has been recycled, for example recycled by 100%, such as HDPE, green PE (e.g., made of sugar cane) and PP.

Alternatively, the material of the head part and/or of the film bag can comprise a compound which is formed by a mixture of green PE with normal PE, a mixture of green PE and recycled PE, or a mixture of normal PE with green PE and recycled PE. Also compounds comprising recycled PP, partially recycled PP and/or normal PP can be used in injection molding processes of the head part and/or as the material of the cartridge wall. The use of such recycled materials leads to a more environmentally friendly cartridge.

The head part and/or the film bag can additionally be reinforced with further material such as through the use of fibers, such as natural fibers, wood fibers, cellulose fibers, hemp fibers, cork fibers, fibers from sunflower seeds, grass fibers, bamboo fibers, flax or carbon fibers.

By way of example, PP, TPE, TPS can each be injection molded together with cork fibers. PE, PP, PLA, PBS, and/or PBAT can be used in injection molding processes together with wood or natural fibers. PA, PE and/or PP can be injection molded together with a wide range of natural fibers. PP and/or PE can be injection molded together with fibers from sunflower seeds. PE, PP, and/or PLA can be injection molded together with fibers grass fibers, flax. It is also possible to injection mold thermoplastic materials not only with one kind of fiber but a mixture of types of fibers.

The cartridge can be a single component cartridge having only one cartridge chamber bound by the flexible film forming the cartridge wall. Such a cartridge can expediently store single component mastic materials, sealants and the like.

A second film can be attached to the head part to cover an internal end face of the head part, optionally with the second film bridging an outlet passage leading from the cartridge chamber to an end of the dispensing outlet. Such a second film can prevent diffusion of components present in the material stored in the cartridge via the end face.

Such cartridges can be filled both using front filling techniques and back filling techniques, with the cartridge having a second film that also extends so as to cover the passage of the dispensing outlet generally only being able to be used in backfilling applications.

In this connection it has been noted that at least one of the head part, the second film and the cartridge wall, such as the first film or a solid cartridge wall, can also be a 3 D printed component.

In this connection it should further be noted that 3 D printing refers to an additive manufacturing process in which material is joined or solidified under computer control to create a three-dimensional object, with material being compiled to form the desired object. In some embodiments, a computer can refer to a smart phone, a tablet, a printer motherboard, a processor/computer in the printer, or any other device with a processor or an electronic controller. The material for the at least one of the head part, the second film and the cartridge wall can be any material, such as liquid molecules or powder grains that are capable of being fused together to form the respective component having the desired properties. In some embodiments, the at least one of the head part, the second film and the cartridge wall can be printed from one or more materials such as PA12, polypropylene, and/or glass filled polyamide. However, the material can be any suitable material or materials.

The film forming the film bag can be a multilayer film having at least two layers formed from different materials. In the preferred choice the film is a five-layer film comprising a sandwich structure in which the outer layer is formed of PE (20 to 40 μm thickness) which is connected to a layer of PA (10 to 20 μm) via a tie layer (1.5 to 2.5 μm). The PA layer in turn is connected via a further tie layer (1.5 to 2.5 μm) to an aluminum or aluminum alloy layer (5 to 10 μm). The aluminum or aluminum alloy layer is in turn connected to a further PA layer (10 to 20 μm) via a further tie layer (1.5 to 2.5 μm) which is then connected to an inner layer corresponding to the inner surface 42, via a via a further tie layer (1.5 to 2.5 μm) with the inner layer having a thickness selected in the range of 45 to 100 μm.

The film forming the film bag can be a three-layer film comprising a sandwich structure in which the first layer is formed of polyethylene (PE) (20 to 40 μm thickness), which is connected to a second layer of aluminum (Al) or of an aluminum alloy (Al alloy) (7 to 12 μm thickness) via a tie layer (1.5 to 2.5 μm thickness). The Al or AL alloy layer is in turn connected to a third PET layer (12 to 15 μm thickness) via a further tie layer (1.5 to 2.5 μm thickness).

The film forming the film bag can be a four-layer film comprising a sandwich structure in which the first layer is formed of PE (20 to 40 μm thickness), which is connected to a second layer of aluminum (Al) or of an aluminum alloy (Al alloy) (7 to 12 μm thickness) via a tie layer (1.5 to 2.5 μm thickness). The Al or AL alloy layer is in turn connected to a third layer of PA (10 to 20 μm thickness) via a tie layer (1.5 to 2.5 μm thickness). The third layer of PA is in turn connected to a fourth layer of PE (15 to 30 μm thickness) via a further tie layer (1.5 to 2.5 μm thickness).

It should be noted that the respective tie layers are not considered to be individual layers of a multi-layered film, they are merely present to ensure a bond is formed between the individual layers.

The materials of the film can differ from the above-mentioned materials as can their respective thicknesses. It should be noted in this connection that the films typically have a thickness selected in the range of 40 to 200 μm, in particular of 70 to 180, in particular of 120 to 170 μm.

According to a further aspect the present disclosure further relates to a method of operating a dispenser, the method comprising the steps of monitoring a pressure or a parameter related thereto on a piston of the dispenser driven by a motor; and on reaching a threshold value associated with the pressure or the parameter related thereto to pause a driving of the motor of the dispenser for a pre-defined time period, before resuming the driving of the motor on continued activation of the dispenser.

According to yet another aspect the present disclosure relates to a dispenser, in particular for spray applications, with the dispenser comprising a receptacle for repeatedly receiving two cartridges, in particular a cartridge assembly comprising two collapsible cartridges, at least one piston connectable to a rack moveable through the receptacle for urging materials stored inside the cartridges towards an outlet of the cartridges for dispensing the materials stored therein. The piston can preferably be permanently connected to the rack. The dispenser further comprises a spray nozzle lever for activating a spray application and a trigger for activating both a movement of the rack of the dispenser in the direction of the receptacle and of the spray nozzle lever between first and second positions.

That is, according to this further aspect, the disclosure further relates to a dispenser that is suitable for use in two-component applications. Nevertheless, the dispenser can also comprise all features as already described above.

Furthermore, the cartridges can either be arranged side by side to one another or coaxial to one another. i.e., with one cartridge being arranged inside of the other cartridge.

In this connection it is noted that the piston can either be directly connected to the rack or indirectly. In the latter case, further components of the dispenser can be arranged between the piston and the rack. Another alternative can be that the piston is only functionally connected to the rack, i.e., the piston will be moved through the receptacle by the rack in order to urge materials stored inside the cartridge towards the outlet. However, in such cases it is not necessary for the piston to be physically connected to the rack or any other component of the dispenser. That is, the piston can be a separate component.

In this connection it should further be noted that in such two-component applications, the two pistons can move in unison, i.e., they can be driven by one single rack. Alternatively, it can also be possible that each piston moves at its own speed. In such cases, usually a gearing mechanism is provided between the two pistons in order to adapt the motor speed for each piston individually.

Additionally, it is noted that for the above mentioned two-component applications the two pistons can either travel the same distance when being pushed by the rack, i.e., at a 1:1 ratio, or they can travel different distances, i.e. for example at a 2:1 ratio or 3:1 ratio and so on. Both options are possible for both side-by-side applications, i.e., with the cartridges being arranged next to one another, as well as coaxial applications, i.e., with the cartridges being arranged coaxially.

### BRIEF DESCRIPTION OF THE DRAWINGS

Embodiments of the invention will be explained in more detail hereinafter with reference to the drawings.

FIG. 1 illustrates a perspective view of a dispenser:

FIGS. 2A and 2B illustrate a side view and a top view of the dispenser of FIG. 1:

FIGS. 3A and 3B illustrate a detailed view of interior parts of the handle of FIG. 1 in a photograph and a further side view of the dispenser of FIG. 1 with the cartridge assembly removed from the receptacle of the dispenser;

FIGS. 4A to 4D illustrate views of a collapsible cartridge:

FIGS. 5A to 5D illustrate views of a support sleeve:

FIGS. 6A to 6F illustrate views of a cartridge assembly; and

FIG. 7 illustrates a block diagram indicating how the dispenser of FIG. 1 can be operated.

### DETAILED DESCRIPTION

In the following the same reference numerals will be used for parts having the same or equivalent function. Any statements made having regard to the direction of a component are made relative to the position shown in the drawing and can naturally vary in the actual position of application.

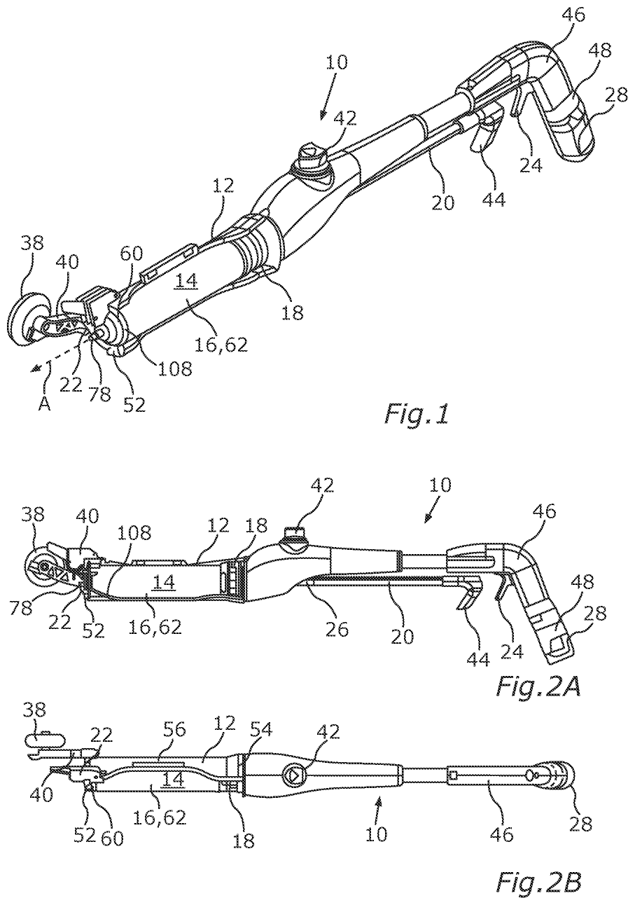

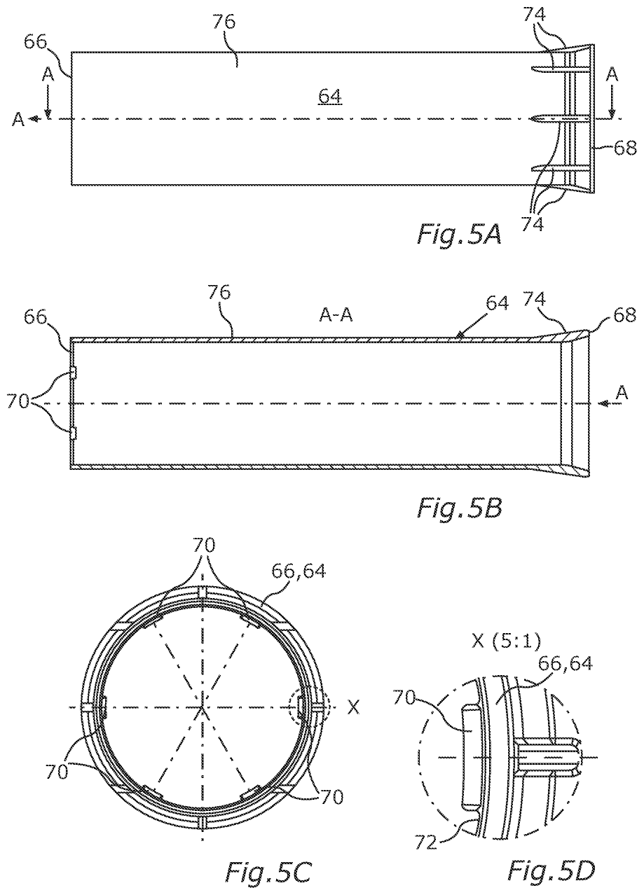

FIG. 1 is a perspective view of a dispenser 10 for spray applications. The dispenser 10 comprises a receptacle 12 for repeatedly receiving a cartridge assembly 16 comprising a collapsible cartridge 14 having a film bag 62 as a cartridge wall, a piston 18 connected to a rack 20 moveable through the receptacle 12 and configured to urge the film bag 62 of the collapsible cartridge 14 towards an outlet 80 of the collapsible cartridge 14 for dispensing materials stored therein along a longitudinal Axis A (see FIG. 5A) via a spray nozzle 78.

The piston 18 is permanently connected to the rack 20. In the shown embodiment this is achieved via a screwed connection. In this connection this could be achieved by adhesively bonding or welding/molding the piston 18 to the rack 20.

The dispenser 10 further comprises a trigger 24 for activating a movement of the rack 20 of the dispenser 10 in the direction of the receptacle 12 via a motor 26 (see FIG. 2B). The electric motor 26 is supplied with energy from a battery 28 or via a cable (not shown). The rack 20 is driven by the motor 26.

On activation of the trigger 24, the trigger 24 also activates a movement of a spray nozzle lever 22 for activating a spray application. The trigger 24 is configured to activate both a movement of the rack 20 of the dispenser 10 in the direction of the receptacle 12 via the motor 26 and of the spray nozzle lever 22 between first (a position of rest) and second (a spray position) positions.

A wheel 38 is connected to the front end of the dispenser 10 at which the spray nozzle lever 22 is arranged via a latching mechanism 40. The wheel 38 can be used to guide and move the dispenser 10 along an essentially straight line along the ground or a surface (both not shown). The latching mechanism 40 can be formed by clips that hold the wheel 38 in different positions relative to the dispenser 10.

The dispenser 10 further comprises a clutch 42. The clutch 42 is configured to engage and disengage the rack 20. On engagement of the clutch 42 with the rack 20, the motor 26 can drive the rack 20. On disengagement of the clutch 42 from the rack, the rack 20 can be manually pushed and pulled by a user thereof.

If the dispenser 10 is in the dispense position the clutch 42 can, for example, be turned anti-clockwise into the load/unload position in which the cartridge 14 can be loaded/unloaded from the receptacle 12. Following the loading of a new cartridge 14, the clutch 42 can then, for example, be moved clockwise, in order to place the clutch 42 into the dispense position for dispensing materials via the dispenser 10.

Once a cartridge assembly 16 is removed from the dispenser 10 a user thereof can push the clutch 42 to disengage the rack 20 and then pull this back via the hook 44 attached thereto.

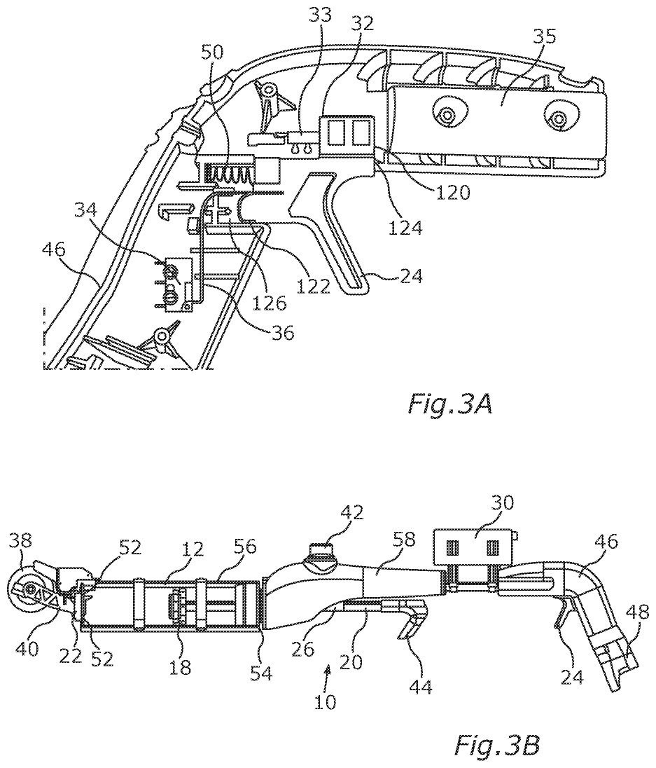

The hook 44 is arranged at the opposite end of the rack 20 to the piston 18 (see in particular FIG. 3B in this regard).

The dispenser further comprises a handle 46 at which the trigger is arranged. The handle 46 also comprises a battery slot 48 into which the battery 28 can be removably placed. The battery 28 can be removed for replacement and/or for charging in a non-shown docking station that can optionally be supplied with the dispenser 10.

The receptacle 12 has a front end 52 configured to receive an outlet end of a cartridge assembly 16. The outlet end comprising a head part 60 of the cartridge 14 having an end plate 108 that sits within the receptacle 12 and abuts the front end 52 thereof. The receptacle 12 also has a rear end 54 at which the piston 18 is arranged in the fully retracted position of the rack 20. The front end 52 is connected to the rear end 54 via a sidewall 56. A support sleeve 64 of the cartridge assembly 16 is placed over the piston 18 at the rear end 54 on insertion of the cartridge assembly 16 into the receptacle 12 of the dispenser 10.

A housing 58 is arranged at the rear end 54 of the receptacle 12. The housing 58 accommodates both the motor 26 and parts of the clutch 42.

FIGS. 2A and 2B show a respective side view and a top view of the dispenser 10 of FIG. 1. The latching mechanism 40 is configured to latch the wheel 38 into a first spray position and a second spray position. The first spray position being shown in these Figures. In this position the wheel 38 can come into contact with a surface in order to guide the dispenser 10 at the surface via the wheel 38. In a non-shown second position, the wheel can be folded backwards. This position is favored if the spray action is to be carried out freehand in order to avoid contamination of the wheel 38 with a material that is currently being dispensed.

FIG. 3A shows a detailed view of interior parts of the handle 46 of the dispenser of FIG. 1 in a photograph. The trigger 24 is formed by a trigger lever that is biased via a second spring 50 with respect to the handle 46. On depressing the trigger lever 24, this is axially moveable along the longitudinal axis A.

For this purpose, the trigger lever 24 has first and second guides 120, 122 that move in first and second slots 124, 126 of the handle 46. The first slot 124 is arranged above the trigger lever 24 and the second slot 126 is arranged at about half of a height of the trigger lever 24.

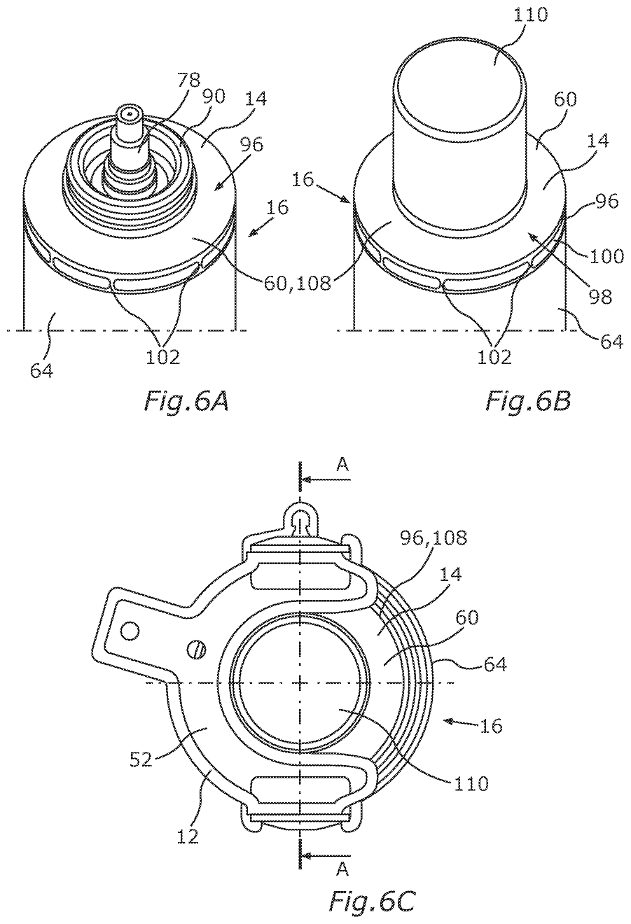

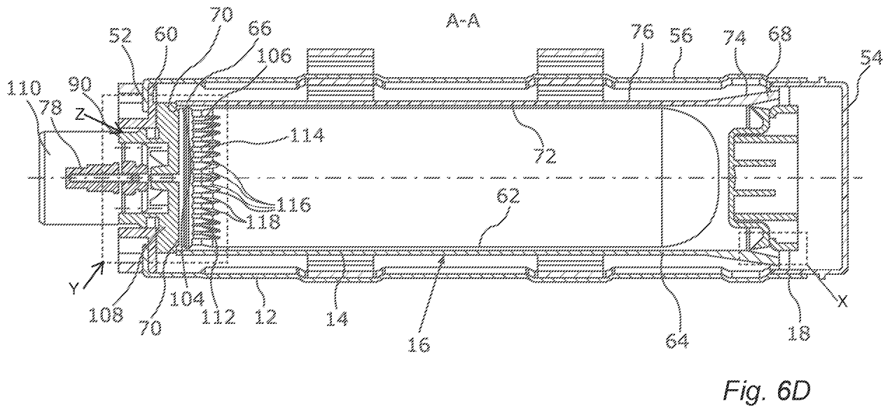

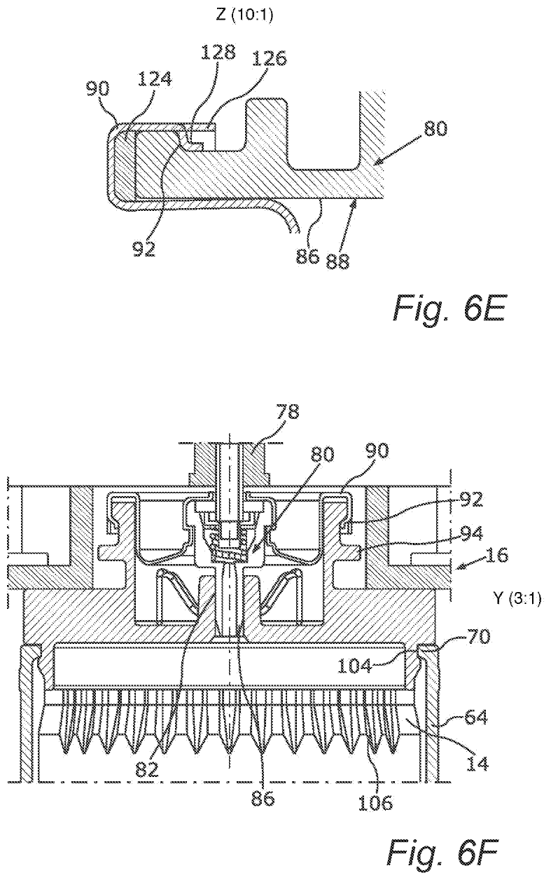

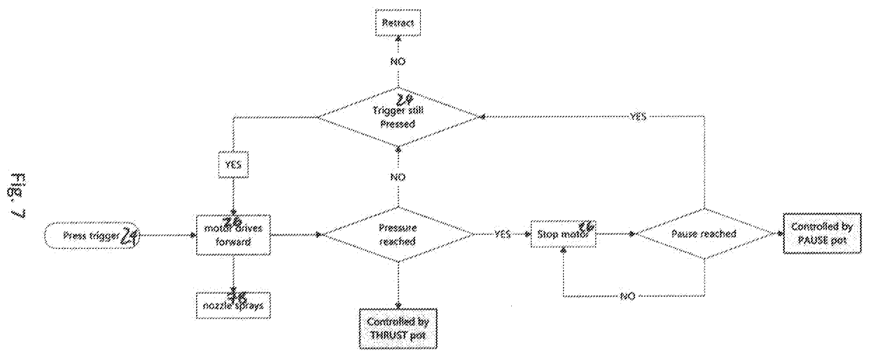

On pressing the trigger lever 24, the first guide 120 entrains an end of a cable 32 fixed via a clamp 33. This cable is a Bowden cable 32 which engages the spray nozzle lever 22 and causes this to pivot relative to its position of rest. As the spray nozzle lever 22 pivots it comes into contact with a spray nozzle 78 (see e.g. FIGS. 1 and 6A) in its spray position. The spray nozzle 78 is arranged at the cartridge assembly 16 in order to activate a spraying function of the cartridge assembly 16. The spray function respectively the spray position is brought about by tilting the spray nozzle 78 away from the longitudinal axis A. For this purpose, a non-shown pivot arrangement is arranged at the front end 52 of the receptacle 12.

The second guide 122 is in operative connection with a switch 34 via a spring 36. The spring 36 in the shown embodiment is of L-shape. Activation of the switch 34 activates the motor 26 via non-shown electric cables.

The non-shown electric cables can be guided at one side of a boss 35 arranged at the other side of the first guide 120 with respect to the clamp 33. The cable 32 is preferably guided on the other side of the boss 35 as the electric cables in order to protect these from the moving Bowden cable 32.

The switch operation can be checked by listening for the switch clicking without the power of the dispenser 10 being on.

Releasing the trigger lever 24, releases the pressure on the switch 34 stopping the motor 26. The bias of the second spring 50 also urges the trigger 24 via the second guide 122 to move back into its storage position. This simultaneously also moves the first guide back into the position of rest thereby moving the Bowden cable 32, such that the spray nozzle lever 22 is moved back into its position of rest releasing the spray nozzle 78 from the spray position to stop a spray application.

In order to obtain an as uniform as possible biasing force on the trigger lever 24, the second spring 50 is arranged at approximately half of the height of the trigger lever 24.

FIG. 3B shows a further side view of the dispenser 10 of FIG. 1 with the cartridge assembly 16 removed from the receptacle 12 of the dispenser 10.

The dispenser 10 further comprises a controller 30, arranged between the housing 58 and the handle 46. The controller 30 is adapted to vary at least one of a speed of the motor, and a power output of the motor, the controller 30 is optionally also configured to detect a pressure on the piston 18 or a parameter related thereto and to adapt the speed of the motor 26, and the power output of the motor 26 in dependence on the detected pressure or the parameter related thereto.

The controller 30 is configured to monitor the drive of the rack 20 by the motor 26 after the switch 34 has been activated and on reaching a threshold value for a pressure on the piston 18 or a parameter related thereto is configured to stop driving the rack 20 for a pre-defined time period.

The pressure on the piston 18 or a parameter related thereto in the present example are related to and measured by the drive current of the motor 26. When a certain current is registered the motor 26 is stopped via the controller 30 and the pressure built up on the film bag cartridge 14 permits the paint stored in the cartridge 14 to be sprayed out of the cartridge 14 via the spray nozzle 78.

After a pre-defined pause time period the motor 26 is driven forward again until the current threshold is registered again or the switch 34 is disengaged. This has the advantage of reducing motor run time and so extends battery life.

The pre-defined pause time period is dependent on the viscosity of the liquid stored in the cartridge 14 and the temperature of use of the cartridge 14. Other ways of measuring the pressure on the film bag cartridge 14 or a parameter related thereto can be achieved by a pressure sensor and/or a strain gauge.

This pause time period can be selected in the range of 0.1 to 10 s, in particular in the range of 0.3 to 5 s, most preferably in the range of 0.4 to 3.5 s.

The pressure on the piston 18 or the parameter related thereto can thus be determined by one of a motor current, a pressure sensor, a strain gauge or a different kind of sensor associated therewith. These sensors are preferably arranged within the dispenser 10 in order to be protected from the environment.

It is also possible that further sensors (not shown) are integrated into the dispenser 10, such as a temperature sensor. A temperature sensor is e.g., provided in order to measure the environmental temperature and thus to automatically adapt the pause time period in view of the temperature if this has an influence on the spray behavior of a certain material. Similarly, a GPS sensor or the like could be provided in order to determine a precise position of use of the dispenser 10.

In this connection it should be noted that the dispenser 10 could also be designed for a 2K side by side cartridge 14 (not shown) having two separate chambers each comprising a respective film bag. The receptacle of the dispenser 10 would then be designed to fit this side by side cartridge. The dispenser 10 would then also comprise two pistons 18 each being connected to a respective rack 20. The two racks 20 could be driven by one and the same motor 26 or by different motors or with a transmission switched therebetween.

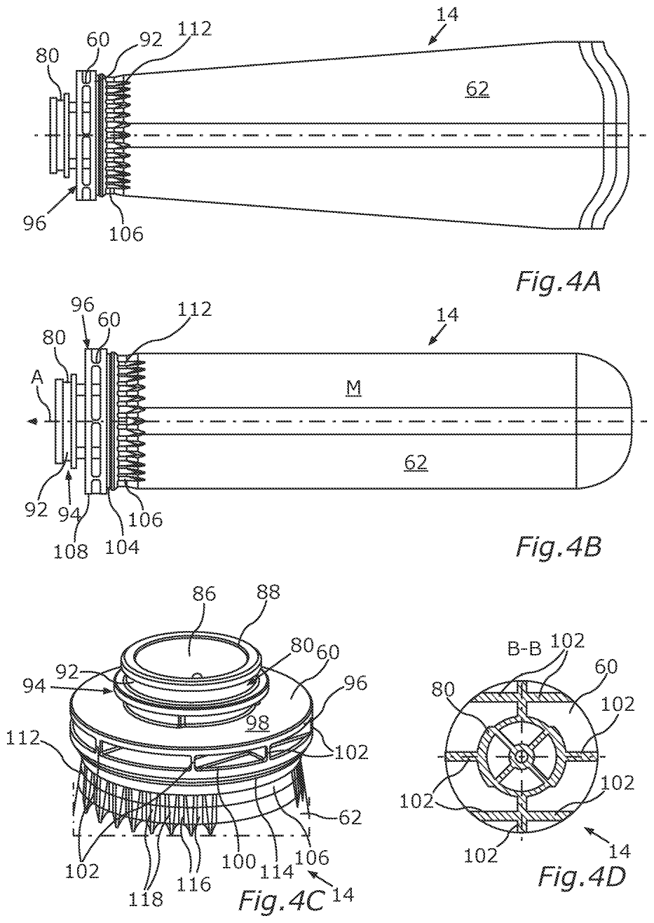

FIGS. 4A to 4D show various views of the collapsible cartridge 14.

The collapsible cartridge 14 comprises a film cartridge wall 62 non-releasably attached to a collar 106 of a solid head part 60 as a film bag. The head part 60 comprises an outlet 80 integrally formed therein.

The head part 60 has a double layered structure 96 with first and second layers 98, 100 as an end plate 108 for the film bag. The end plate 108 is formed radially around the outlet 80. The collar 106 is formed at the second layer 100 of the double layered structure 96 and extends in parallel to the longitudinal axis A away from the first layer 98.

The first and second layers 98, 100 are connected to one another via a plurality of walls 102 extending in parallel to the outlet 80. The different walls are either directly or indirectly connected to the outlet 80 as shown e.g., in FIG. 4D.

The double layered structure 96 is a support structure that is provided in order to strengthen the outlet 80 in use of the cartridge 14. In this way a buckling of the end plate 108 can be avoided when large pressures are applied on the cartridge 14 via the piston 18 and this engages the front end 52.

The head part 60 comprises an annular groove 104 in which noses 70 of a support sleeve (see e.g., FIG. 5c) are received, preferably by a snap-in connection or the like.

As shown in FIG. 4A, the rear end of the film bag 62 has not yet been closed and the bag is empty. The rear end of the film bag 62 can be welded shut to form a seal and the rounded end as shown in FIG. 4B.

The film bag cartridge 14 can be filed with material M either from the front via the outlet (front filling). For this purpose, the bag is welded shut prior to filling. Alternatively, the film bag cartridge 14 can be filed with material M via the rear end thereof (back filling) prior to welding the rear end of the cartridge 14 shut.

The collar 104 of the head part 60 of the cartridge 14 comprises an undulating outer surface 112. Specifically, the collar 104 of the cartridge 14 comprises two such outer surface portions 112 at two sides of the collar 104. The two portions can be spaced apart from one another by an angle of 10 to 45° with respect to one another and the longitudinal axis A.

The undulating outer surfaces 112 of cartridge 14 comprise a plurality of troughs 116 and peaks 118 arranged sequentially adjacent to one another.

A front end 114 of the film bag 62 is connected to the outer surface of the collar 104 in the example shown in FIGS. 4A to 4C, but could similarly be attached to an inner surface of the collar 104, or be connected between the inner and an outer surface of the collar 104.

In this connection the number of troughs 116 per undulating outer surface portion can be selected between 3 and 20, especially between 5 and 15. In the example shown 13 such troughs 116 are provided per surface portion. i.e. 26 troughs are provided at the collar 104.

The arrangement of the troughs 116 and peaks 118 ensures a stable connection to the front end 114 of the film bag, as it permits sufficient clearance in the core of an injection mold to tightly secure the film bag 62 to the head part 60.

FIGS. 5A to 5D show views of a support sleeve 64. The support sleeve 64 is intended for use with a cartridge assembly 16. The support sleeve 64 comprises first and second ends 66, 68 and the longitudinal axis A extends between the first and second ends 66, 68. The support sleeve 64 is configured to receive the collapsible cartridge 14 and the first end 66 is configured to be connected to the head part 60, the second end 68 of the support sleeve 64 extends radially outwardly from the longitudinal axis.

As shown more clearly in the view of FIG. 5C and FIG. 6F, the first end 66 of the support sleeve 64 comprises two to 15 noses 70 arranged at an inner surface 72 of the support sleeve at the very end of the support sleeve 64. The noses 70 are adapted to be connected to the annular groove 104 of the head part 60 of the collapsible cartridge 14.

At the second end the last 5 to 25% of the support sleeve 64 can be configured to flare outwardly, e.g., in the manner of a trumpet. The second end 68 of the support sleeve 64 hence extends radially outwardly from the longitudinal axis A. This aids in the insertion of the piston 18 into the support sleeve 64 on use of a cartridge assembly 16.

The second end 68 further comprises a plurality of reinforcing ribs 74 on an outer surface 76 of the support sleeve 64. These ribs 74 on the one hand support the support sleeve 64 on insertion of the piston 18 into the support sleeve 64 and on removal from e.g., an injection mold in which it is formed to prevent the support sleeve 64 from cracking on removal. The support sleeve 64 can be formed from the same material as the piston 18 or a similar material.

In this connection it should be noted that the support sleeve 64 and/or the piston 16 can be formed from one of the following materials: polyethylene (PE), high density polyethylene (HD-PE), polybutylene terephthalate (PBT), polyamide (PA) and polypropylene (PP), polyoxymethylene (POM), poly tetrafluoroethylene (PTFE), or a polymer or a thermoset material having a hardness measured with the Shore D Durometer selected in the range of 55 D to 100 D. Most preferably, the reusable piston 18 is made of only one composition, preferably comprises only one polymeric material.

The polymeric material can include polymer blends, i.e., can also contain additives, primers and/or polar groups and cannot be one single virgin polymer.

FIGS. 6A to 6F show various views of a cartridge assembly 16. The cartridge assembly 16 is configured for insertion into a dispenser 10, such as the one shown in connection with FIGS. 1 to 3B.

The cartridge assembly 16 comprises the collapsible cartridge 14 having the film cartridge wall 62 and the solid head part 60 and the support sleeve 64. The support sleeve 64 being configured to receive the collapsible cartridge 14 and the first end 66 being configured to be connected to the head part 60, and the second end 68 of the sleeve 64 extending radially outwardly from the longitudinal axis A, i.e., having a trumpet shape.

As indicated in FIG. 6A, the cartridge assembly 16 comprises a spray nozzle 78 connected to the outlet 80 of the head part 60 of the collapsible cartridge 14. The spray nozzle 78 is of common design and is activated by tilting the nozzle 78 from its position of rest in a manner known per se.

The spray nozzle 78 is part of an assembly and is fixed to the plastic head part 60 via a metal plate 90 as will be described in detail in connection with FIGS. 6E and 6F.

FIG. 6B shows a cap 110 placed over the spray nozzle 78 to form a closed cartridge assembly 16 in order to protect an accidental activation of the spray nozzle 78 in a storage state of the cartridge assembly 16.

As shown in FIG. 6C, the cap 110 and the front end 52 of the receptacle 12 are formed complementary to one another such that the closed cartridge assembly 16 can be inserted into the dispenser 10.

FIG. 6D shows a section through the cartridge assembly of FIG. 6C when this is arranged in the receptacle 12, with the piston 18 inserted into the second end 68 of the support sleeve 64. An end plate 108 of the head part 60 is in contact with the front end 52 of the receptacle 12. The front end 52 is dimensioned to receive the outlet 80 with the cap 110 arranged thereat.

The spray nozzle 78 is inserted into the outlet 80 of the cartridge 14. The spray nozzle 78 is crimped into place at the outlet 80 of the head part 60 of the collapsible cartridge 14 by the metal plate 90, the metal plate 90 is folded into an undercut 92 present at an outer surface 94 of the outlet 80.

As shown in FIG. 6E in detail an outer rim 126 of the metal plate 90 is crimped to form a crimped rim 128 that is deflected into the undercut 92 to permanently hold the metal plate 90 and hence the spray nozzle 78 at the outlet 80.

A seal 124 is arranged between the metal plate 90 as a secondary seal to avoid any liquid that may come from the cartridge from exiting the outlet 80 via the metal plate rather than via the spray nozzle 78.

In order to prevent materials from even reaching this part of the spray nozzle 78, a seal 82 is arranged between an outer first end surface 84 of the spray nozzle 78 and an inner surface 86 of an outlet passage 88 of the outlet 80 of the head part 60 of the collapsible cartridge 14 as indicated in FIG. 6F. The spray nozzle 78 comprises a check valve that is displaced by tilting the spray nozzle 78 away from the longitudinal axis A.

FIG. 7 shows a block diagram indicating how the dispenser 10 of FIGS. 1 to 3B can be operated for a spray application. A user switches on the dispenser 10 and in order to carry out a spray application presses the trigger 24.

This causes the motor 26 to drive forward in order to pressurize the film bag 62 of the cartridge assembly 16. At the same time the nozzle 78 sprays materials M from the cartridge assembly 16. The nozzle 78 sprays materials M from the cartridge assembly 16 as long as the trigger 24 is pressed and the materials in the film bag 62 are pressurized respectively as long as this is not empty.

The controller 30 continuously monitors to see if the trigger 24 is still pressed. If a determination is made that the trigger 24 is no longer pressed, the rack 20 is retracted sufficiently to release the pressure on the film bag 62 as indicated in the top line of FIG. 7.

As the motor 26 of the dispenser 10 drives the rack 20 forward the controller 30 detects the pressure exerted on the film bag 62 by the piston 18 by measuring the current and on reaching a threshold value associated with the pressure or the parameter related thereto, the controller is configured to pause (stop) a driving of the motor 26 of the dispenser 10 for a pre-defined time period, before again resuming the driving of the motor 26 on continued activation of the dispenser 10 via the trigger 24.

The threshold value can be varied by adapting a THRUST potentiometer associated therewith.

The duration of the pause can be varied by adapting a PAUSE potentiometer associated with a delay of the controller 30.

It should be noted that the function of the THRUST potentiometer and of the PAUSE potentiometer can be incorporated into software of the controller 30 and be carried out by implementing the software.

It should be noted that in an alternative design of the dispenser 10 that the motor 26 can always be on and drive the rack 20 when the trigger lever 24 is pressed and the spray function is activated via the spray nozzle 78.

In order to use the dispenser 10, the clutch 42 is moved into the load/unload position. In this position a user can move the rack 20 from a position of use as shown e.g., in FIG. 3b to a fully retracted position as shown e.g., in FIG. 2a. If the rack 20 and hence the piston 18 is not fully retracted a new cartridge 14 cannot be inserted into the dispenser 10.

In order to guide the cartridge assembly 16 into engagement with the piston 18 and into the receptacle 12, the second end 68 of the support sleeve 64 is formed as a trumpet shape. This ensures that one can guide the piston 18 reliably into the support sleeve 64.

Following insertion of a new cartridge 14 or cartridge assembly 16 into the receptacle 12, the clutch 42 is moved into the dispensing position. Following activation of the dispenser 10 by pressing the on button, the trigger 24 can be pressed to dispense materials from the cartridge assembly 16, for the first dispense after inserting a new cartridge assembly it takes approximately 1 to 3 seconds to get to a steady line in dependence on the materials stored in the cartridge assembly 16.

When the cartridge assembly is empty, i.e., the rack 20 has been moved via the motor 26 into the fully deployed position, the spray will stop, a user can then release the trigger 24. It should be noted that the rack 20 can momentarily retract on releasing the trigger 24 even before the cartridge assembly 16 is emptied. This is done in order to release a pressure on the cartridge assembly 16 to prevent further paint M from exiting the cartridge assembly 16 in a storage state thereof.

If the cartridge assembly 16 is empty or if a change of cartridge assembly 16, e.g., for selection of a different color is desired, the clutch 42 is again moved into the load/unload position. For removal of a cartridge assembly 16, the rack 20 and hence the piston 18 into the fully retracted position in order to allow the cartridge assembly 16 to be removed from the receptacle 12.

1. A dispenser, comprising:
a receptacle configured to repeatedly receive a cartridge;
a piston connectable to a rack moveable through the receptacle and configured to urge materials stored inside the cartridge towards an outlet of the cartridge to dispense the materials stored therein
a spray nozzle lever configured to activate a spray application and a trigger for activating both a movement of the rack of the dispenser in the direction of the receptacle and of the spray nozzle lever between first and second positions.

2. The dispenser according to claim 1,
wherein the cartridge is one of a collapsible cartridge comprising a film bag, and a solid cartridge.

3. A dispenser, comprising:
a receptacle configured to repeatedly receive a cartridge assembly comprising a collapsible cartridge;
a piston connectable to a rack moveable through the receptacle and configured to urge a film bag of the collapsible cartridge towards an outlet of the collapsible cartridge to dispense materials stored therein, the piston being permanently connected to the rack; and
a trigger configured to activate movement of the rack of the dispenser in a direction of the receptacle;
a spray nozzle lever configured to activate a spray application, and the trigger being configured to activate both a movement of the rack of the dispenser in the direction of the receptacle and of the spray nozzle lever between first and second positions.

4. The dispenser according to claim 1,
further comprising a motor, and the rack configured to be driven by the motor.

5. The dispenser according to claim 4,
further comprising a controller configured to vary at least one of a speed of the motor, and a power output of the motor.

6. The dispenser according to claim 5, wherein
the controller is configured to detect a pressure on the piston or a parameter related thereto and to adapt the speed of the motor, and the power output of the motor in dependence on the pressure detected or the parameter related thereto.

7. The dispenser according to claim 5,
wherein the controller is configured to drive the rack and upon reaching a threshold value for a pressure on the piston or a parameter related thereto to stop driving the rack for a pre-defined time period and to drive the rack again following the pre-defined time period.

8. The dispenser according to claim 6,
wherein the pressure on the piston or the parameter related thereto are determined by one of a motor current, a pressure sensor and a strain gauge.

9. The dispenser according to claim 1,
wherein the spray nozzle lever is configured to be moved by a cable.

10. The dispenser according to claim 2,
wherein the trigger is connected to a switch via a spring.

11. The dispenser according to claim 1,
further comprising a wheel arranged at a front end of the dispenser having the spray nozzle lever.

12. The dispenser according to claim 11, further comprising
a latching mechanism arranged between the spray nozzle lever and the wheel, the latching mechanism being configured to latch the wheel into a first spray position and a second spray position.

13. The dispenser according to claim 1,
further comprising a clutch configured to engage and disengage the rack to enable manual pushing and pulling of the rack.

14. A cartridge assembly for insertion into the dispenser according to claim 1, the cartridge assembly comprising:
the cartridge, the cartridge being a collapsible cartridge having a film cartridge wall and a solid head part; and
a support sleeve comprising first and second ends and a longitudinal axis extending between the first and second ends, the support sleeve being configured to receive the collapsible cartridge and the first end being configured to be connected to the head part, and the second end of the sleeve extending radially outwardly from the longitudinal axis so as to have a trumpet shape.

15. The cartridge assembly according to claim 14, wherein the first end of the support sleeve comprises two to 15 noses configured to be connected to the solid head part of the collapsible cartridge.

16. The cartridge assembly according to claim 15, wherein the head part comprises an annular groove in which the noses are received.

17. The cartridge assembly according to claim 14, wherein the second end further comprises a plurality of reinforcing ribs on an outer surface of the second end.

18. The cartridge assembly according to claim 14, further comprising a spray nozzle connected to an outlet of the head part of the collapsible cartridge.

19. The cartridge assembly according to claim 18,
wherein a seal is arranged between an outer first end surface of the spray nozzle and an inner surface of an outlet passage of the outlet of the head part of the collapsible cartridge.

20. The cartridge assembly according to claim 18,
wherein the spray nozzle is crimped into place at the outlet of the head part of the collapsible cartridge by a metal plate, the metal plate being folded into an undercut present at an outer surface of the outlet.

21. The cartridge assembly according to claim 14, wherein the head part has a double layered structure with first and second layers being connected to one another via a plurality of walls extending parallel to the longitudinal axis of the support sleeve when the head part is attached to the support sleeve.

22. The cartridge assembly according to claim 14,
wherein a material is stored in the collapsible cartridge of the cartridge assembly.

23. A cartridge assembly for insertion into the dispenser according to claim 1, the cartridge assembly comprising
the cartridge, the cartridge being a solid cartridge having a solid cartridge wall and a solid head part; and
a support sleeve comprising first and second ends and a longitudinal axis extending between the first and second ends, the support sleeve being configured to receive the solid cartridge and the first end being configured to be connected to the head part, and the second end of the sleeve extending radially outwardly from the longitudinal axis so as to a trumpet shape.

24. The cartridge assembly of claim 23,
wherein the cartridge comprises first and second wall ends, the first wall end comprising the head part and the second wall end extending radially outwardly from a longitudinal axis extending between the first and second wall ends.

25. A support sleeve for a cartridge, the support sleeve comprising:
first and second ends and a longitudinal axis extending between the first and second ends, the support sleeve being configured to receive the cartridge and the first end being configured to be connected to the head part, the second end of the support sleeve extending radially outwardly from the longitudinal axis.

26. The support sleeve according to claim 25, wherein the first end of the support sleeve comprises two to 15 noses, or at least the second end further comprises a plurality of reinforcing ribs on an outer surface of the second end.

27. A support sleeve for a cartridge assembly, in particular in accordance with claim 25,
the support sleeve being configured to receive at least one of a collapsible cartridge or a solid cartridge.

28. A collapsible cartridge for use in a cartridge assembly or with a support sleeve, the collapsible cartridge comprising:
a film cartridge wall non-releasably attached to a collar of a solid head part, the head part comprising an outlet integrally formed therein and comprising a double layered structure with first and second layers as an end plate formed radially around the outlet, the collar being formed at the second layer of the double layered structure extending parallel to a longitudinal axis away from the first layer) and with the first and second layers being connected to one another via a plurality of walls extending n-parallel to the outlet and being connected to the outlet.

29. A method of operating a dispenser in accordance with claim 1, the method comprising:
monitoring a pressure or a parameter related thereto on a piston of the dispenser driven by a motor; and
upon reaching a threshold value associated with the pressure or the parameter related thereto, pause a driving of the motor of the dispenser for a pre-defined time period, before resuming the driving of the motor on continued activation of the dispenser.

30. The dispenser in accordance with claim 1, wherein the receptacle is configured to repeatedly receive two cartridges.

31. The dispenser according to claim 30, the receptable receptacle is configured to repeatedly receive the two cartridges arranged side by side to one another.

32. The dispenser according to claim 30, the receptacle is configured to repeatedly receive the two cartridges arranged in a coaxial manner, with a fit cartridge of the two cartridges being arranged inside of a second cartridge of the two cartridges.
